(19) United States
(12) Patent Application Publication
(10) Pub. No.: US 2008/0077975 A1
(43) Pub. Date: Mar. 27, 2008

(54) COMPUTER SYSTEM AND METHOD OF CONTROLLING ACCESS TO COMPUTER

(76) Inventors: Kiminori Sugauchi, Yokohama (JP); Toui Miyawaki, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/830,918

(22) Filed: Jul. 31, 2007

(30) Foreign Application Priority Data
Aug. 2, 2006 (JP) 2006-210833

(51) Int. Cl. G06F 21/20

(52) U.S. Cl. 726/4

(57) ABSTRACT

When there is competition for use of a blade PC, a legitimate user is determined by inputting a predetermined number of pieces of additional authentication information. Only when it is possible to determine the legitimate user based on the additional authentication information, the legitimate user is allowed to continuously use the blade PC. Further, while continuous use is allowed, next time a use request is made, additional information of an amount corresponding to that with which determination of the legitimate user has been possible is requested. Thus, when there is competition for access to the blade PC, use is ensured for the legitimate user without sacrificing security.

### BACKGROUND OF THE INVENTION

The present invention relates to a technique regarding management of a computer system which accesses a remote computer via a network, such as a remote desktop computer.

There is disclosed a technique in which data or applications stored in hard disks of personal computers (PCs) used by individual users are aggregated in blade servers to be allocated to the users (see, for example, Nikkei Communications, Feb. 1, 2005, pp. 72 to 73).

A system that uses the technique described in Nikkei Communications, Feb. 1, 2005, pp. 72 to 73, is called a blade PC system. In the blade PC system, a determination has to be made as to whether a user who has accessed a bladed PC (hereinafter referred to as blade PC) is a legitimate user.

As a determination method, for example, there is a method that requires authentication information at time of logging-on. However, there is a risk that the authentication information may leak when confirmation is made based on only the authentication information. In this case, the blade PC is easily accessed, allowing illegal users to use the blade PC.

To prevent such illegal use, a technique has been provided, which notifies a preregistered legitimate user of access made through a route different from a normal access route, for each access, while requesting authentication information, and double-checks whether the access is made by a legitimate user (see, for example Japanese Patent Laid-open Publication No. 2002-91917).

### SUMMARY OF THE INVENTION

According to the blade PC system, because main applications are arranged in the blade PC of the server, the user has to frequently access the blade PC. Especially in cases of accessing the blade PC when mobile, as in a business trip or the like, the user frequently carries out a process of activating or terminating the blade PC, interrupting or resuming access, and the like. Thus, the method of checking user access, in addition to authentication processing based on authentication information at the time of access, is complex for legitimate users.

The user accesses the blade PC from anywhere through a network. Thus, while there is no problem when unit with which checking can be constantly made, such as a cellular phone, is available, users who have no fixed checking unit capable of being preregistered cannot use this technique. Further, for example, even the legitimate user cannot use the blade PC if the user carries no device or application for receiving return confirmation, such as when the user has forgotten to bring a portable phone. When a user impersonating a legitimate user (fraudulent user) executes access many times, the legitimate user has to reject access from the fraudulent user each time. To prevent this state, the access may be temporarily stopped or authentication information may be changed. However, none of these methods are realistic, because the temporary access stoppage disables user usage, and the problem cannot be dealt with quickly when authentication information is changed, as in the case of a credit card.

Generally, the blade PC system employs a configuration in which, in a case where the blade PC is used, when another access is made to the same blade PC, in other words, when there is competition in access to the same blade PC, the user who first accesses the blade PC is given priority while a subsequent access attempt is rejected, or conversely, the subsequent access attempt is given priority while the previously access is suddenly terminated.

In the former case, when the fraudulent user is first using the blade PC, the legitimate user who has subsequently accessed the blade PC may not be able to use the blade PC. In the latter case, when the fraudulent user accesses the blade PC in use by the legitimate user, connection of the legitimate user may be cut off. In either configuration, there are inconveniences.

In the case of checking based on only the authentication information, when the authentication information leaks, according to the current blade PC system, the blade PC is used by the fraudulent user as described above, and thus an illegitimate user can not only access the blade PC but also has exclusive use thereof. In other words, when there is competition in access to the blade PC, use by the legitimate user cannot always be secured.

The present invention has been made in view of the foregoing circumstances, and it is therefore an object of the invention to provide a technique which can secure use for a legitimate user without sacrificing safety when there is competition in access to a blade PC.

To achieve the above-mentioned object, according to the present invention, in a management system which manages user access to the blade PC, when there is competition for use of the blade PC, a legitimate user is determined based on a predetermined number of additional pieces of authentication information, to permit the legitimate user to use blade resources. Moreover, once competition occurs, after that, the additional authentication information, with which determination of the legitimate user can be made, is requested at the time of accessing.

Specifically, according to an aspect of the present invention, there is provided a blade system, including: a blade server including a plurality of computers; a client terminal; and a blade server management apparatus which manages access from the client terminal to the blade server, in which: the blade server management apparatus includes: authentication information holding unit which holds authentication information and at least one piece of additional authentication information for each user; access control unit which receives a use request when authentication information matched with the authentication information held in the authentication information holding unit is transmitted together with the use request for using the blade server via the client terminal; use state determination unit which determines whether the server requested to be connected by the use request is in a competitive state where the blade server is already used according to the same authentication information, upon reception of the use request by the access control unit; and startup control unit which requests transmission of the additional authentication information upon determining that the server is in the competitive state, permits connection of a legitimate user determined based on the requested additional authentication information, and cuts off connection of other users; and the startup control unit determines, when only additional authentication information transmitted from one user matches the additional authentication information held in the authentication information holding unit, a user who has transmitted the matched additional authentication information to be a legitimate user.

According to the present invention, when there is competition for access to the blade PC, it is possible to secure use for the legitimate user without sacrificing safety.

### BRIEF DESCRIPTION OF THE DRAWINGS

In the accompanying drawings:

FIG. 1 is a diagram showing a configuration of a system according to a first embodiment of the present invention;

FIGS. 2A and 2B are diagrams each showing an example of a table which stores user information and information of a blade PC according to the first embodiment;

FIG. 3 is a diagram showing an example of a user authentication information table according to the first embodiment;

FIG. 4 is a diagram showing an example of an additional information input screen according to the first embodiment;

FIG. 5 is a process flowchart showing an access control process according to the first embodiment;

FIG. 6 is a process flowchart showing a startup control process according to the first embodiment;

FIG. 7 is a diagram showing a configuration of a system according to a second embodiment of the present invention;

FIG. 8 is a diagram showing an example of a user information table according to the second embodiment;

FIG. 9 is a process flowchart showing an access control process according to the second embodiment;

FIG. 10 is a diagram showing an example of a screen which prompts authentication information change according to the second embodiment;

FIG. 11 is a process flowchart showing a time limit monitor process according to the second embodiment;

FIG. 12 is a diagram showing another example of the screen which prompts authentication information change according to the second embodiment;

FIG. 13 is a diagram showing a configuration of a system according to a third embodiment of the present invention;

FIG. 14 is a diagram showing a configuration of a system according to a fourth embodiment of the present invention;

FIG. 15 is a diagram showing a configuration of a system according to a fifth embodiment of the present invention;

FIG. 16 is a process flowchart showing a log-on monitor process according to the fifth embodiment; and

FIG. 17 is a process flowchart showing a log-on control process according to the fifth embodiment.

### DESCRIPTION OF THE PREFERRED EMBODIMENTS

### First Embodiment

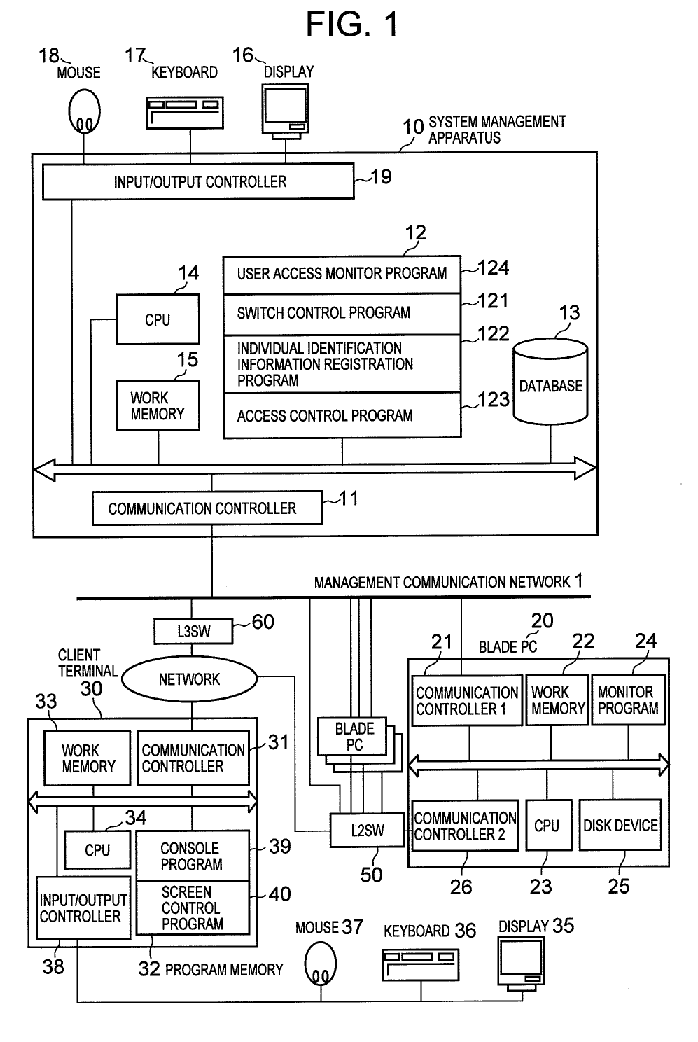

Preferred embodiments of the present invention will be described below with reference to the accompanying drawings. First, referring to FIGS. 1 to 7, a first embodiment of the invention will be described.

FIG. 1 is a diagram showing a configuration of a blade PC system which remotely uses a blade PC according to this embodiment. The system includes a blade PC 20 having a configuration equivalent to a PC used by a user, a client terminal 30 as an interface through which the user uses the blade PC 20, and a system management apparatus 10 which manages the entire system. The system management apparatus 10 and the blade PC 20 are interconnected through a management communication network 1. The client terminal 30 is connected to the management communication network 1 via a network 2 and a switch L3SW60. The client terminal 30 can be connected to the blade PC 20 via the network 2 and a network switch (LS2W) 50.

This embodiment will be described below by taking an example in which the number of blade PC's 20 is equal to the number of users of the system. However, the number of blade PC's 20 is in no way limitative.

The blade PC 20 has a configuration similar to that of a normal PC, and includes a central processing unit (CPU) 23, a work memory 22 which temporarily stores data or a program needed by the CPU 23 to execute a process, a disk device 25 which holds data or an application of a user allocated to the blade PC, a first communication controller 21 as an interface for communicating with the system management apparatus 10, a second communication controller 26 as an interface for communicating with the client terminal 30, and a program memory 24 which stores a program. The program memory stores a monitor program 241 to monitor user access state. The first and second communication controllers 21 and 26 may be configured as one communication controller. The disk device 25 may be arranged in a storage device provided as a separate device.

The client terminal 30 includes a communication controller 31 as an interface for communicating with the blade PC 20 and with the system management apparatus 10 via the network 2, a program memory 32 which stores a program, a central processing unit (CPU) 34, a work memory 33 used as a work area when the CPU 34 executes the program stored in the program memory 32, a display 35 as an output device which displays screen information received from the blade PC 20, a keyboard 36 and a mouse 37 which are input devices as interfaces for inputting data, and an input/output controller 38 which controls the output and input devices.

The program memory 32 of the client terminal 30 stores a console program 39 which realizes a function of exchanging information with the system management apparatus 10 and a screen control program 40 which realizes a communication interface between the blade PC 20.

The system management apparatus 10 includes a central processing unit (CPU) 14, a communication controller 11 for communicating with the client terminal 30 used by the user, the blade PC 20, and the L2SW50, via the management communication network 1, a work memory 15 which functions as an arithmetic operation area and a result storage area when the CPU 14 executes the program, a database 13 which stores user information or configuration information of the blade PC 20, a program memory 12 which stores programs regarding management, a display 16 as an output device which displays management information such as use state of the blade PC 20, a keyboard 17 and a mouse 18 as input devices for inputting various pieces of information regarding interruption, and an input/output controller 19 which controls the input and output devices.

The program memory 12 stores management programs. The management programs include a switch control program 121 for controlling the L2SW50 connected to the client PC, an individual identification information registration program 122 for registering information necessary for identifying a user in the database, an access control program 123 for controlling use of the blade PC 20 by the user, and a user access monitor program 124.

The CPU 14 loads and executes the user access monitor program 124 in the work memory 15 to realize a user access monitor function. The user access monitor function communicates with the monitor program 24 of the blade PC 20 to ascertain file access or startup of an application in the blade PC 20, thereby monitoring access to the blade PC 20 from the outside. Also, through communication with a network apparatus (e.g., L2SW50), data flowing through the network via the network apparatus is monitored.

Similarly, the CPU 14 executes the switch control program 121 to realize a switch control function. The switch control function controls the L2SW50 to control access from the client terminal 30 to the blade PC 20.

Similarly, the CPU 14 executes the individual identification information registration program 122 to realize an individual identification information registration function. The individual identification information registration function registers authentication information received from the user, in a user authentication information table to be described later.

Similarly, the CPU 14 executes the access control program 123 to realize an access control function. The access control function controls access from the user to the blade PC 20 via the client terminal 30.

According to this embodiment, the management programs (121 to 124) are installed in one apparatus. However, the programs may be installed in respective individual management apparatuses, and data may be exchanged among the programs via the network.

Next, information stored in the database 13 will be described. Pieces of information stored in the database 13 include a user information table 210 which stores information of a user of the blade PC system of this embodiment, a blade PC management table 220 which stores information regarding the blade PC 20, and a user authentication information table 300 which holds user authentication information.

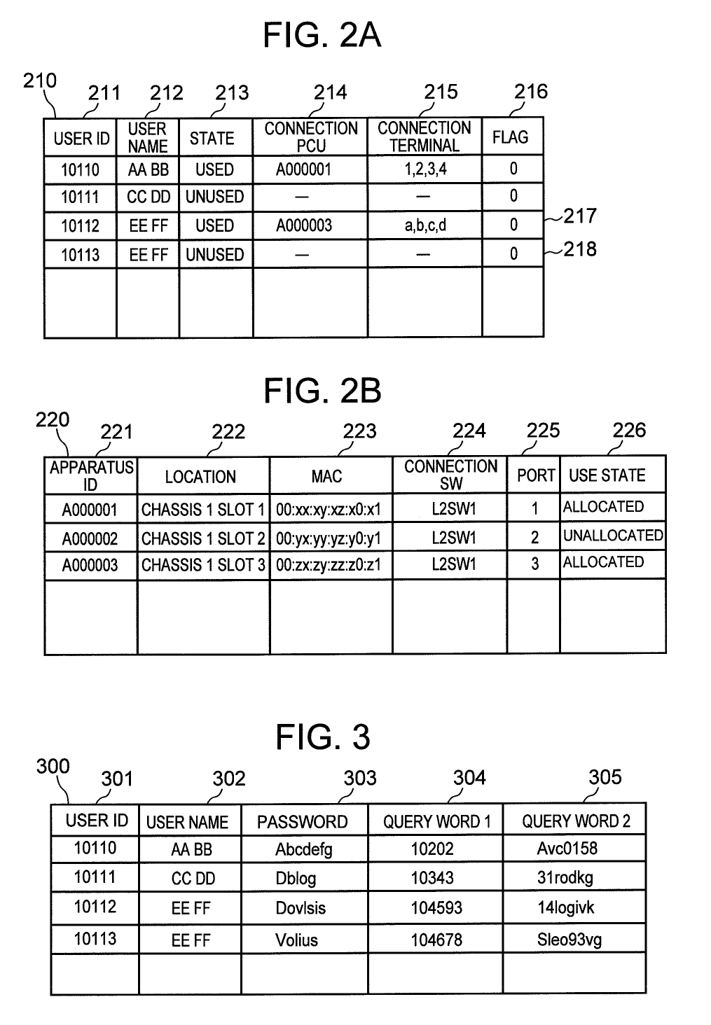

FIG. 2A is a diagram showing an example of the user information table. As shown in the figure, in the user information table 210 of this embodiment, a user name 212, a state 213, a connection PCU 214, a connection terminal 215, and a flag 216 are registered in association with a user ID 211.

The user ID 211 is a number for uniquely designating a user, and data which is a part of authentication information used for authentication. The user name 212 is a name of the user specified by the user ID 211.

The state 213 is information indicating whether the user specified by the user ID 211 is using the blade PC 20, and any of “USED”, “INTERRUPTED”, and “UNUSED” is stored. In the case of “USED”, a blade PC 20 allocated to the user is started up, and the user accesses the blade PC 20 via the client terminal 30. In the case of “INTERRUPTED”, while the blade PC allocated to the user is started up, there is no connection between the blade PC 20 and the client terminal 30. In the case of “UNUSED”, the user is not using the blade PC 20. In other words, the blade PC 20 allocated to the user is stopped.

The connection PCU 214 indicates an apparatus ID of the blade PC 20 allocated to the user specified by the user ID 211. This value refers to a value of an apparatus ID of the blade PC table 220 to be described later.

The connection terminal 215 is an identifier for specifying the client terminal 30 used by the user.

The flag 216 records whether a competitive use state regarding authentication information allocated to the user specified by the user ID 211, in other words, a state where a plurality of users requests access the blade PC 20 by using the same user ID 211, has occurred. If no competitive use state has occurred, a value 0 is recorded in the flag 216. If a competitive use state has occurred, the number of times of using additional information described below is recorded. If competition has occurred to disable determination of which user is a legitimate user, −1 is recorded.

According to this embodiment, authentication information varies from one blade PC 20 to another. In other words, when plural of blade PC's 20 are allocated to one user, the user accesses the blade PC's 20 by using different pieces of authentication information. For example, information regarding records 217 and 218 of the user information table 210 of FIG. 2A indicate that users of “EE FF” of the same user name 212 have two user ID's 211 of “10112” and “11113”. The user of “EE FF” of the user name 212 can use two blade PC's 20 by using the respective user ID's 211.

FIG. 2B is a diagram showing an example of the blade PC management table 220 according to this embodiment. As shown in the figure, in the blade PC management table 220, a location 222, media access control (MAC) 223, a connection SW 224, a port 225, and a use state 226 are registered in association with an apparatus ID 221.

The apparatus ID 221 uniquely identifies each blade PC 20. The location 222 is information for identifying a position at which the blade PC 20 is arranged. For example, the blade PC system stores information indicating which slot of which chassis a blade is The MAC address 223 uniquely designates a second communication controller 26 of the blade PC 20 which communicates with the client terminal 30 used by the user. The connection SW 224 provides information indicating a network apparatus directly connected to the second communication controller 26 of the blade PC 20. The port 225 provides information indicating an identifier of a connected port. The use state 226 provides information indicating a latest use state of the blade PC 20, and one of “ALLOCATED” and “UNALLOCATED” is registered. If a blade PC 20 specified by the apparatus ID 221 is allocated to an optional user, “ALLOCATED” is registered. If there is no user allocated to the blade PC 20 specified by the apparatus ID 221, “UNALLOCATED” is registered.

FIG. 3 is a diagram showing an example of the user authentication information table 300. As shown in the figure, in the user authentication information table 300 of this embodiment, a user name 302, a password 303, a query word (1) 304, and a query word (2) 305 are registered in association with a user ID 301.

The user ID 301 and the user name 302 uniquely identify a user, and are the same as those used by the items of the same names of the user information table 210. In other words, in the case of a user registered in the user information table 210, an ID and a name the same as the user ID 211 and the user name 212 of the user information table 210 are registered in the user ID 301 and the user name 302, respectively.

The password 303 provides authentication information preregistered by the user. When a combination of the user ID 301 and the password 303 matches, an authentication success is determined.

Each of the query words (1) 304 and (2) 305 provides additional authentication information preregistered by the user. Generally, when the blade PC 20 is used, user validity is authenticated based on the user ID 301 and the password 303. As another method, validity may be authenticated by asking a user to provide information of a certificate issued from a third party in place of the password. When such information is leaked and a fraudulent user and a legitimate user compete with each other, the query words (1) 304 and (2) 305 are used as second and third authentication information items. The password 304 and the query words (1) 304 and (2) 305 are registered by the user using the individual identification information registration program 122. However, such information may also be set by an operation manager.

In the user authentication information table 300, serial numbers starting from 1 (not shown) are added as indexes to the query words. The index specifies which of the query words is used when a plurality of query words are registered for one user as described below. According to this embodiment, the number of query words is 2. However, this number is in no way limitative.

Next, a screen example of an additional authentication information input screen 600 displayed on the output device 35 of the client terminal 30 according to screen data transmitted from the system management apparatus 10 to the client terminal 30 to prompt the user to input additional authentication information will be described. The screen is displayed by a console function of the client terminal 30. Information necessary for displaying is appropriately provided by an access control function of the system management apparatus 10, to the client terminal 30.

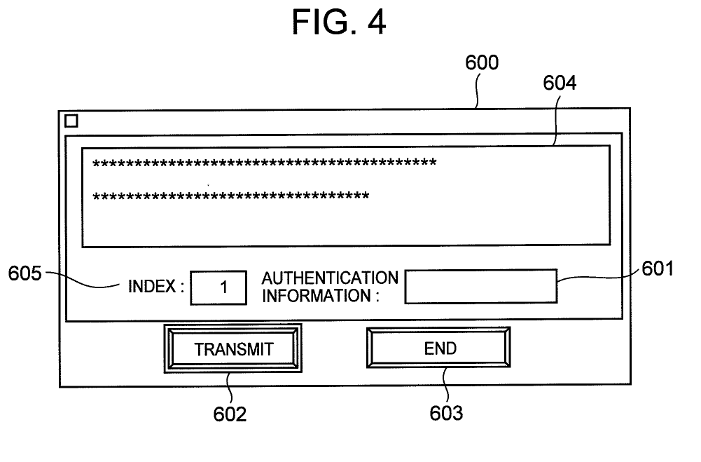

FIG. 4 is a diagram for illustrating an example of the additional information input screen 600 according to this embodiment. As shown in the figure, the additional information input screen 600 includes a message display section 604 for displaying a message, an index display section 605 for displaying an index of additional authentication information requested to be input, an authentication information input section 601 for receiving an entry of the additional authentication information, a transmission button 602 used for establishment of the additional authentication information input to the authentication information input section 601 and accepting transmission of the additional authentication information to the system management apparatus 10, and an end button 603 for accepting an input end.

In the message display section 604, a message corresponding to a state of transmitting the additional information input screen 600 among preregistered messages is displayed. According to this embodiment, situations in which entry of additional authentication information is prompted include cases in which, when the user is authenticated after a use request is received from a user, there is at least one flag 216 that is registered in association with the user ID 211 of the user who has transmitted the use request, and there is a record of past competition, and cases in which competition occurs when user authentication is finished, and the blade PC 20 allocated to the user is started up.

In the former case, a record of illegal use of the authentication information is made, and a request to display a message to prompt entry of additional authentication information is made to the console function, to be displayed on the client terminal 30. In the latter case, the current occurrence of competition is notified, and a request to display a message to prompt entry of additional authentication information is made to the console function, to be displayed on the client terminal 30.

Next, a process realized by each of the functions will be described.

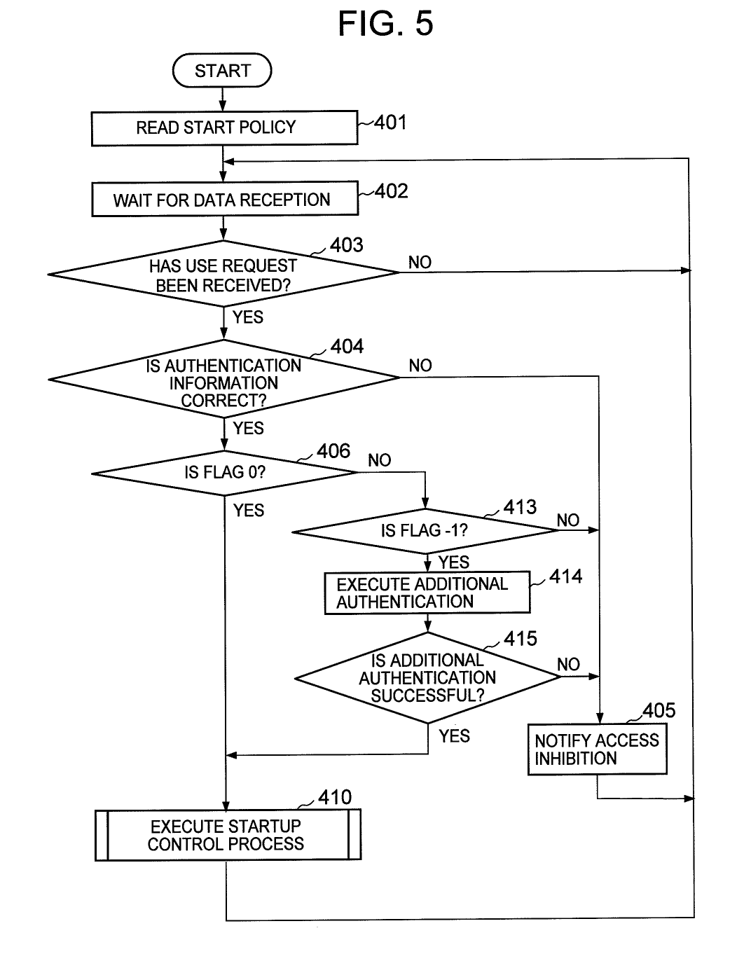

First, an access control process realized by the access control function will be described. The access control function determines the validity of a user when a use request is transmitted from the user, and permits access only when the user is judged valid. FIG. 5 shows flow of the access control process of the access control function.

When started up, the access control function collects information (operation information) necessary for operating the access control program 123, such as communication timeout (step 401). Upon collection of the operation information, the access control function waits for a request from a user (step 402).

The access control function checks for reception of a use request and authentication information from the user each predetermined time-period (step 403). If none has been received, a request wait state is set (step 402).

On the other hand, if the use request and the authentication information have been received from the user, the access control function determines whether the received authentication information is correct authentication information (step 404). In this case, the access control function determines whether a combination of a user ID and a password contained in the received authentication information matches that of the user ID 301 and the password 303 of the user authentication information table 300. Authentication information is determined to be correct if a match is obtained. Authentication information is determined to be invalid if a match is not obtained.

When the authentication information is determined to be invalid, the access control function notifies the user that access is not possible to the blade PC 20 (step 405).

When the authentication information is determined to be correct, the access control function determines whether a competitive state has occurred in the past regarding the authentication information (step 406). In this case, the access control function refers to the user information table 210 to check the value of the flag 216 of the user ID 211 that matches the user ID contained in the authentication information.

If a result of the checking shows that the value of the flag 216 is 0, the access control function receives a use request from the user to execute a startup control process (step 410). After the startup control process, the access control function returns to the state of waiting for a use request from the user (step 402). The startup control process will be described later in detail.

If the value of the flag 216 is 1 or more (step 413), the access control function requests additional authentication information from the user of a use request transmission source (step 414). In this case, the access control function transmits a request for displaying the additional information input screen 600 to the console function of the client terminal 30 to prompt the user to input information. When the value of the flag 216 is 1 or more, as described above, it means that competition has occurred in the past and the user has accessed the blade PC 20 by using the additional authentication information.

The access control function receives a user ID and a query word transmitted by the user, and determines whether the received set of the user ID and the query word matches the set of the user ID 301 and the query word (1) 304. If they match each other, a judgment is made of an authentication success (step 415).

If the value of the flag 216 is determined to be 2 in step 413, a process similar to that of steps 414 and 415 is repeated a number of times equal to the value of the flag 216. However, in step 415, the set of the user ID and the query word transmitted by the user is compared with the set of the user ID 301 and the query word (2) 305 to determine matching. If a match is obtained, an authentication success is determined.

According to this embodiment, because the registered number of query words is 2, the process of steps 414 and 415 is repeated up to two times. Generally, however, the process is repeated a number of times equal to a value stored in the flag 216. In these cases, for example, a counter n is introduced; the counter n is initialized to 1 in step 413; and steps 414 and 415 are executed based on query words having indexes matching the counter n. When authentication is successful, the counter is incremented by 1, and the process of steps 414 and 415 is repeated until the counter n exceeds the number stored in the flag 216.

If the authentication is successful in step 415, the access control function receives a use request from the user to execute a startup control process (step 410). The access control function returns to the state of waiting for the use request from the user (step 402).

On the other hand, if the authentication is not successful in step 415, the access control function notifies access inhibition (step 405), and then returns to the state of waiting for the use request from the user (step 402).

If the value of the flag 216 is determined to be −1 or less in step 413, the access control function notifies access inhibition (step 405), and then returns to the state of waiting for the use request from the user (step 402).

The access control process when the access control function receives the use request from the user has been described. When receiving a stop or interruption request from the user, similarly, the access control function refers to the user information table 210 to authenticate the user of the request source, and executes a process according to a request from a successfully authenticated user.

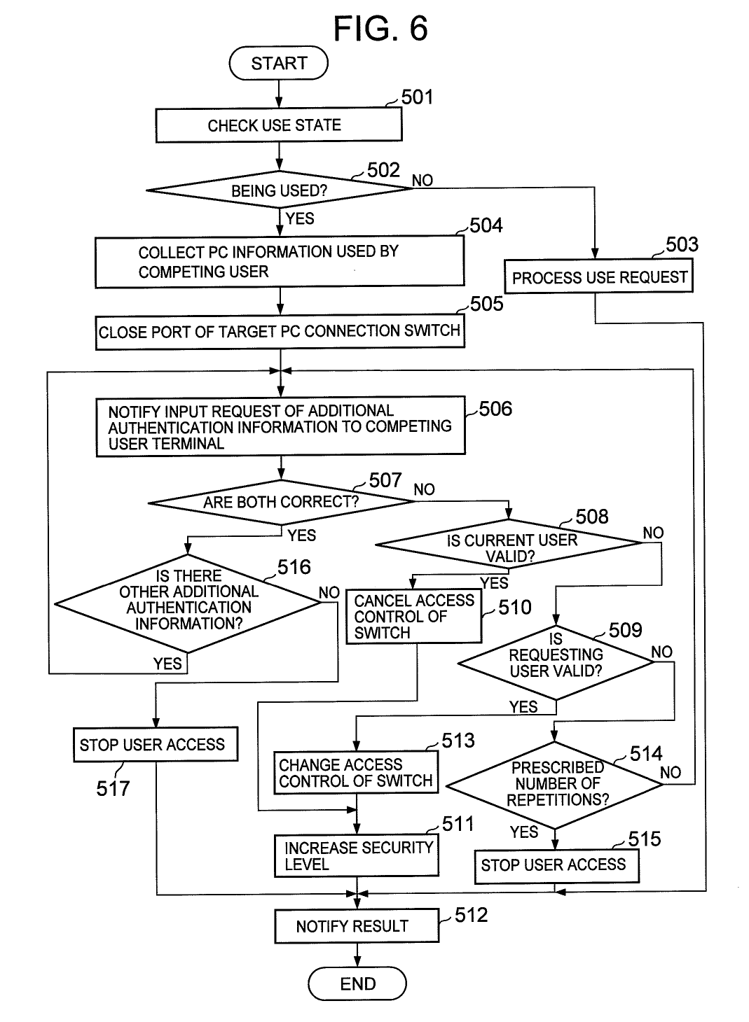

Next, the startup control process of step 410 will be described. FIG. 6 shows flow of the startup control process of this embodiment.

To understand a use state of a user who has transmitted a use request, the access control function determines contents of the state 213 registered corresponding to the user ID 211 of the user information table 210 (steps 501 and 502).

If the state 213 is other than “USED”, in other words, if the state 213 is “UNUSED” or “INTERRUPTED”, it is determined that the user specified by the user ID 211 is not using a blade PC 20 at present, and a use request process is carried out, with the received use request as a normal use request (step 503).

A process carried out as the use request process by the access control function is as follows. The blade PC 20, associated in advance to the transmitted user ID is allotted, and the allocated blade PC 20 is started up. A use state 226 registered in the blade PC management table 220 corresponding to an apparatus ID 221 of the started-up blade PC 20 is set to “ALLOCATED”. A state 213 of a user registered corresponding to a user ID 211 of a use request transmission source of the user information table 210 is set to “CONNECTED”. An apparatus ID 221 which is an identifier of the allocated blade PC 20 is registered in the connection PCU 214, and an identifier of the client terminal 30 used by the user of the request transmission source is registered in the connection terminal 215.

When the use request process ends, the access control function provides information indicating that use is enabled, to the client terminal 30 used by the user of the use request transmission source (step 512) to finish the process.

On the other hand, if the state 213 is determined to be “USED” in step 502, it means that the blade PC 20 has been allocated by using the same authentication information as the authentication information used by the user who has transmitted the use request, and that there is a user who is using the blade PC 20. In other words, this means that competition has occurred for the authentication information. Accordingly, the access control function collects information of the blade PC 20 where the competition has occurred (step 504). In this case, a blade PC 20 (target blade PC 20) allocated first to the user of the blade PC system using the authentication information is specified, so the connection PCU 214 registered corresponding to the user ID 211 of the user information table 210 is obtained. The connection terminal 216 is also obtained to specify the client terminal 30 used by the competing user. Additionally, a connection SW 224 and a port 225 of data where the obtained connection PCU 214 is registered as the apparatus ID 221 in the blade PC management table 220 are obtained.

The access control function closes the port 225 of the switch SW 224 connected to the target blade PC 20 (step 505). In this case, control is performed on a switch control function realized by the CPU 14 executing the switch control program 121 to issue an instruction to discard a packet transmitted and received via the obtained port 225, to the obtained connection SW 224.

The access control function notifies an input request of additional authentication information to each of the client terminals 30 used by both competing users (step 506). This notification is carried out by transmitting a request to display the additional authentication information input screen 600 to the console function of the client terminal 30.

The access control function refers to the user authentication information table 300 to collate pieces of additional authentication information received from the plurality of competing client terminals 30 (step 507). In this case, whether authentication information registered as the query word (1) 304 matches information transmitted as additional authentication information is determined.

According to this embodiment, a counter m which counts how many pieces of additional authentication information are used is introduced, and an initial value 1 is set in the counter m before step 506. The access control function executes collation below by using additional authentication information having an index corresponding to the counter m in the user authentication information table 300.

If it is determined in step 507 that there is information unmatched with the query word (1) 304 among the pieces of transmitted authentication information, and additional authentication information transmitted by the user currently using the system matches the registered query word (1) 304 (step 508), in other words, if the user of the current use is determined to be a legitimate user, the access control of the switch L2SW50 executed in step 505 is released (step 510). In this case, the access control function controls the switch control function to release filtering conditions set in the switch L2SW50.

The access control function increases the security monitor level (step 511). In this case, the user access monitor function executes a process of obtaining a log of file access to the blade PC 20 or monitoring transmission and reception of data between the blade PC 20 and the external apparatus.

According to this embodiment, monitoring of access to the blade PC 2 is strengthened. However, accessible range may be limited. For example, the switch access control function limits access to servers other than the blade PC 20, or authority of file access on the blade PC 20 is limited. A value of the counter m at this time is recorded in the flag 216 of the user information table 210. The access control function notifies information indicating permission of continuous use, to the client terminal 30 used by the user who currently is using the system, and information indicating use inhibition, to the client terminal 30 of the use request transmission source (step 512), and the process is finished.

If it is determined in step 508 that the additional authentication information transmitted from the user of the current use does not match the query word (1) 304, and if additional authentication information transmitted from the user who has transmitted a new use request matches the registered query word (1) 304 (step 509), in other words, if the user who has transmitted the new use request is determined to be a legitimate user, the access control function controls the switch control function to change control of the L2SW50 to receive only access from the client terminal 30 which has transmitted the use request (step 513). An identifier of the client terminal 30 registered in the connection terminal 215 of the user management table 210 is replaced by an identifier of the client terminal 30 used by the user of the use request transmission source. Then, the process proceeds to step 511.

In step 511, as in the aforementioned case, the security level is increased, and a value of the counter m at this time is recorded in the flag 216 of the user information table 210. Then, the access control function notifies information meaning permission of continuous use to the client terminal 30 of the use request transmission source, and information meaning use inhibition to the client terminal 30 used by the user who currently uses the system (step 512) to finish the process.

If it is determined in step 509 that the additional authentication information transmitted from the user, who has transmitted a new use request, does not match the query word, inputting of authentication a number of predetermined times is prompted, and collation is repeated (step 514).

If there is no matching even after the collation is repeated a predetermined number of times, the access control function performs control so that access is not accepted from any user (step 515). In this case, −1 is substituted for the flag 216 of the user information table 210 to reject a request for access to the corresponding blade PC 20. Information indicating use inhibition is notified to both the client terminal 30 of the user transmission source and the client terminal 30 used by the user of the current use (step 512), to finish the process.

If it is determined in step 507 that the additional authentication information transmitted from the user of the current use and the additional authentication information transmitted from the user who has transmitted the new use request, both match the query word (2) 304, the access control function determines whether there is other additional authentication information (step 516). For example, according to this embodiment, two pieces of additional authentication information are prepared in the user authentication information table 300. Thus, inputting of similar additional authentication information can be permitted once more to authenticate a user. In this case, the counter m is compared with a maximum value N of an index of authentication information of the user authentication information table 300, and presence of additional authentication information is determined if the counter m takes a value smaller than the maximum value N of the index. Then, the counter n is incremented by 1 to return to step 506.

On the other hand, if it is determined in step 516 that no additional authentication information is present, in other words, if the counter m takes a value equal to or more than the maximum value N of the index, access to the user is stopped (step 517). In this case, −1 is substituted for the flag 216 of the user information table 210 to reject a request for access to the blade PC 20. Then, information indicating use inhibition is notified to both of the client terminal 30 of the use request transmission source and the client terminal 30 used by the user of the current use (step 512), to finish the process.

The process at the time of competition in the blade PC 20 of this embodiment has been described. As described above, according to this embodiment, when there is competition for use of the blade PC 20 using the same authentication information, due to authentication information leakage or the like, continuous use is permitted only to the user recognized to be a legitimate user.

However, when competition occurs, the access control function prompts change of the existing authentication information such as a password while permitting continuous use to the legitimate user. When the individual identification information registration function receives new information necessary for authentication such as authentication information from the user or additional authentication information such as a query word to register the information in the user authentication information table 300, the access control function sets 0 in the flag 216 of the user information table 210. Accordingly, the legitimate user uses new authentication information, and can access the blade PC 20 only based on the authentication information.

Thus, according to this embodiment, when a competitive state is set, security is increased, and at the time of a use request thereafter, inputting of authentication information enough to determine a legitimate user is requested. As a result, safety can be maintained.

The first embodiment has been described using example where one blade PC 20 is allocated for each user ID. However, this embodiment is in no way limitative of the invention. A free blade PC 20 may be allocated for each access. The invention is similarly applied to cases where a storage apparatus is installed in the system, data to realize an environment of each user is saved, the data is read therefrom for each allocation of a blade PC 20, and a user PC environment is realized on the allocated blade PC 20.

### Second Embodiment

Next, a second embodiment of the present invention will be described. The second embodiment is similar to the first embodiment in that when competition occurs, control is executed to permit continued use only to a legitimate user. According to this embodiment, after competition occurs, time for use by the legitimate user is limited. Only configurations of this embodiment different from those of the first embodiment will be described.

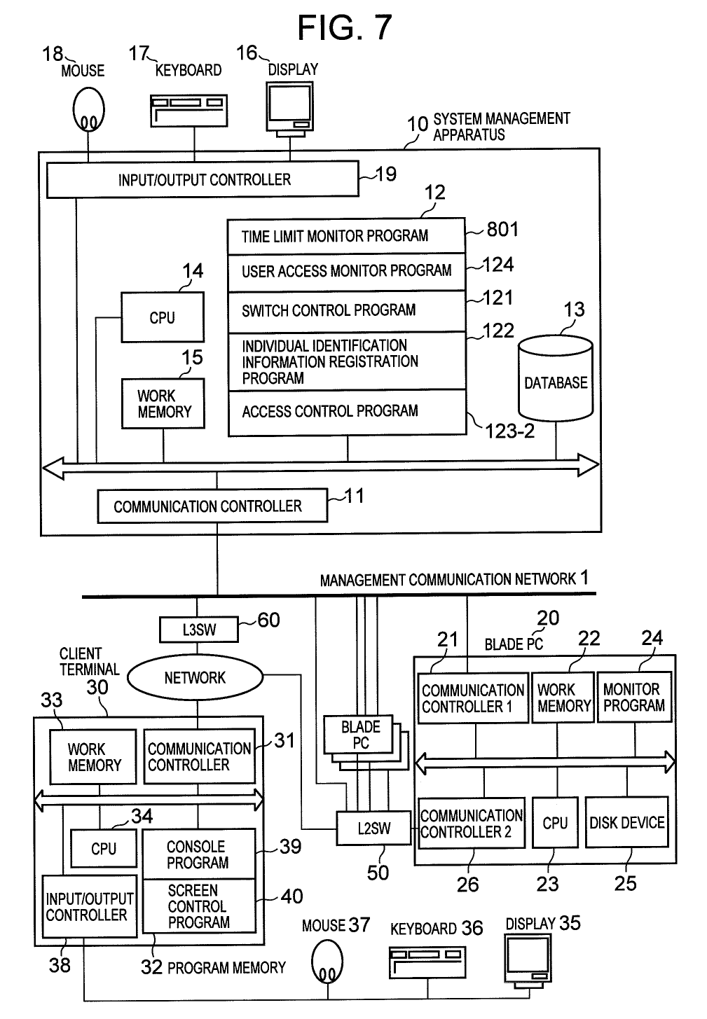

FIG. 7 is a diagram showing a configuration of a blade PC system according to this embodiment. The system configuration of this embodiment is basically similar to that of the first embodiment. However, a function realized by an access control program 123-2 is slightly different from a function realized by the program of the same name in the first embodiment. A system management apparatus 10 of this embodiment further includes a time limit monitor program 801.

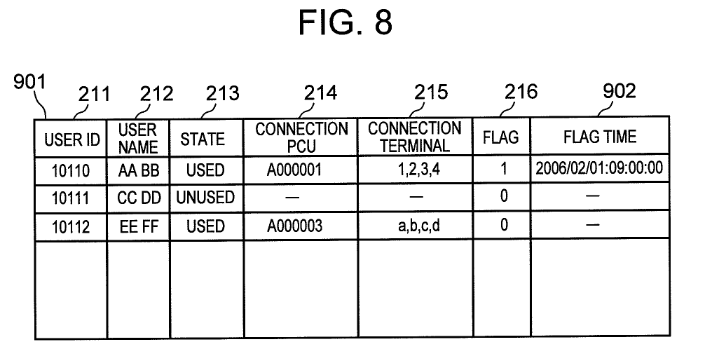

A user information table 210-2 of this embodiment includes flag time 902 in addition to the items registered in the user information table 210 of the first embodiment. FIG. 8 shows an example of the user information table 210-2 of this embodiment. As the flag time 902, time for which a value other than 0 is stored, is registered in a flag 216. This is the time when the system management apparatus 10 recognizes occurrence of competition for a blade PC 20.

An access control program 123-2 of this embodiment is loaded in a work memory 15, and executed by a CPU 14 to realize an access control function. Details thereof will be described below.

The time limit monitor program 801 of this embodiment is loaded in the work memory 15, and executed by the CPU 14 to realize a time limit monitor function. The time limit monitor function monitors time from the occurrence of a competitive state to determine whether the time exceeds a preset time limit.

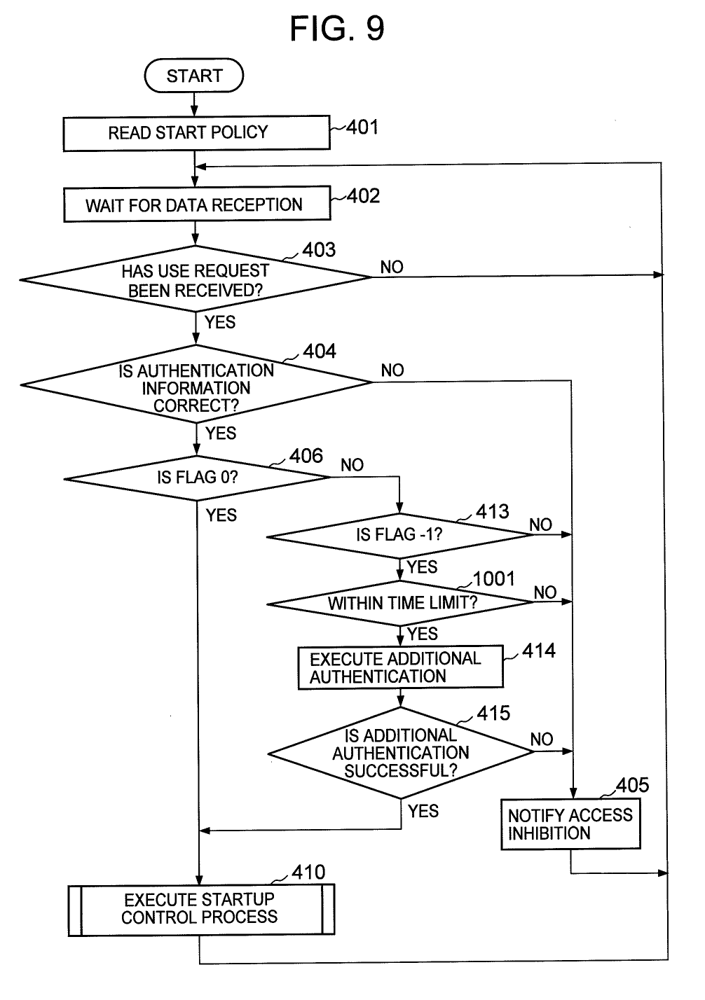

FIG. 9 shows flow of an access control process realized by the access control function of this embodiment.

The flow of the access control process of this embodiment is basically similar to that of the first embodiment. In the drawing, steps similar to those of the first embodiment are denoted by similar step numerals. However, pieces of information collected in step 401 include a use time limit T in addition to information collected according to the first embodiment. The use time limit T is a time for which a use by a legitimate user is permitted, from the time when the system management apparatus 10 recognizes the occurrence of competition, and is preset by a manager or the like. According to this embodiment, to secure safe running, the legitimate user is obligated to update authentication information within the use time limit T.

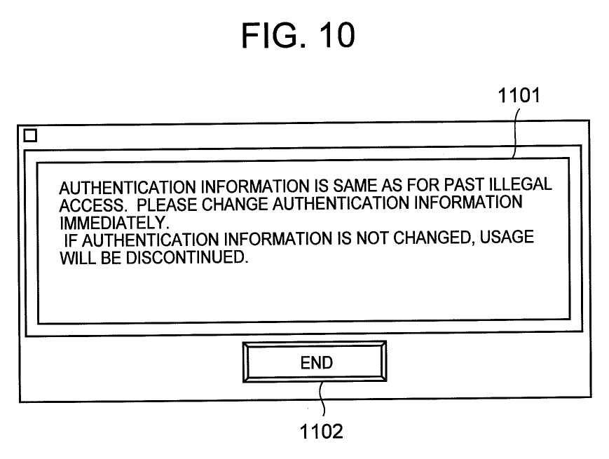

According to this embodiment, if it is determined in step 413 that a value of the flag 216 is equal to or more than 1, the access control function of this embodiment calculates a difference T1 between time of receiving a use request and time registered as flag time 902, and determines whether the calculated difference T1 is equal to or less than the use time limit T (step 1001). If the difference T1 is equal to or less than the use time limit T, additional authentication is carried out. On the other hand, if the difference T1 exceeds the time limit T, the access control function notifies access inhibition to a client terminal 30 of a use request source. In this case, a message prompting change of authentication information is transmitted together with the access inhibition to the client terminal 30. FIG. 10 shows an example of a screen displayed in a display 35 of the client terminal 30.

This screen example includes a message display section 1101 and an end button 1102 which receives an indication of intention to finish. Upon reception of an indication that the end button 1102 has been pressed by a user, the access control function finishes displaying. In this sequence, a password is changed at a timing different from that of the use request. However, by this timing, an individual identification information registration function may be prompted to change the password.

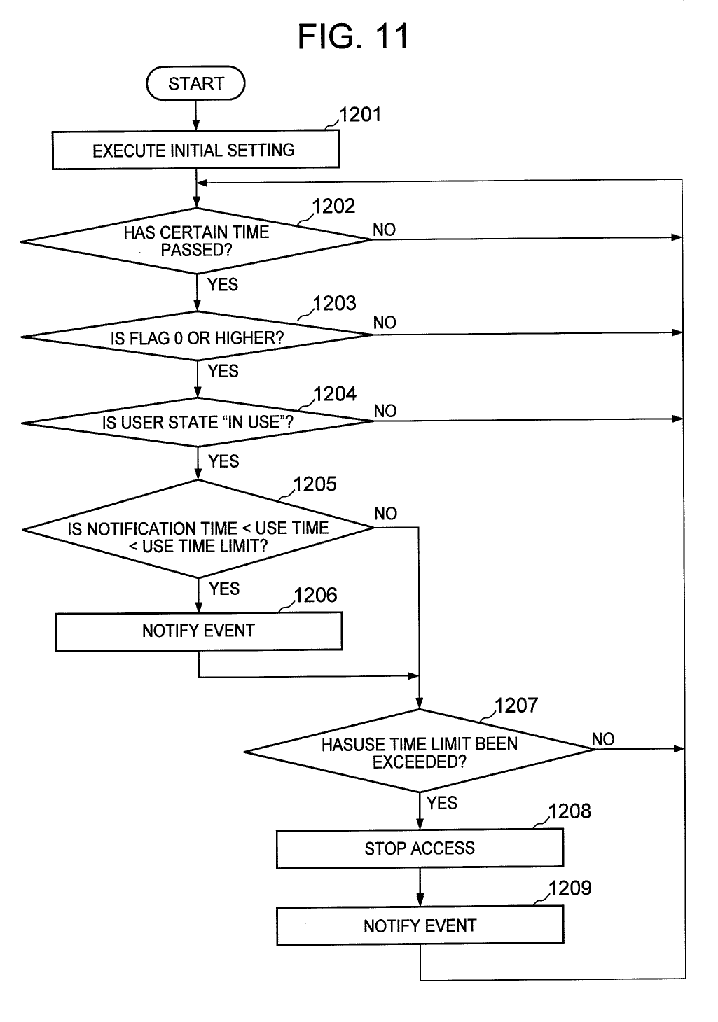

Next, a time limit monitor process of the time limit monitor function of this embodiment will be described. FIG. 11 shows flow of the time limit monitor process of this embodiment. The time limit monitor process of this embodiment may be started at the time of starting up the blade PC system, or may be started when a value of the flag 216 of the user information table 210 of at least one or more users becomes 1.

When started up, the time limit monitor function executes initial setting (step 1201). In this case, the time limit monitor function obtains a use time limit T and a notification time limit T2. The notification time limit T2 is a time within the use time limit T to notify a state where safety is not necessarily secured because of the occurrence of competition, and a state where authentication is preferably changed to the legitimate user. The notification time limit T2 may be a time within the use time limit T, or a time until reaching the time limit T, and, for example, when the use time limit is set to 24 hours, and notification is made after 12 hours, the notification time limit may be set to a value of 50%.

The time limit monitor function checks a state of a user for each predetermined time-period. In this case, when a passage of time is measured, and a passage of the predetermined time-period is detected (step 1202), a determination is made as to whether there is a user in which a value of the flag 216 of the user information table 210-2 is not 0(step 1203).

If there is a user, the time limit monitor function determines information stored in the state 213 (step 1204). If the state is other than “UNUSED”, i.e., is “USED” or “INTERRUPTED”, a difference T3 between current time and the flag time 902 is calculated to determine a relation between the obtained difference T3, the use time limit T, and the notification time limit T2 (step 1205).

If it is determined in step 1205 that the difference T3 between the current time and the flag time 902 is equal to or more than the notification time limit T3 and within the use time limit T, the time limit monitor function notifies access inhibition to the legitimate user (step 1206). In this case, a predetermined message is transmitted as an event notification to the client terminal 30 used by the legitimate user.

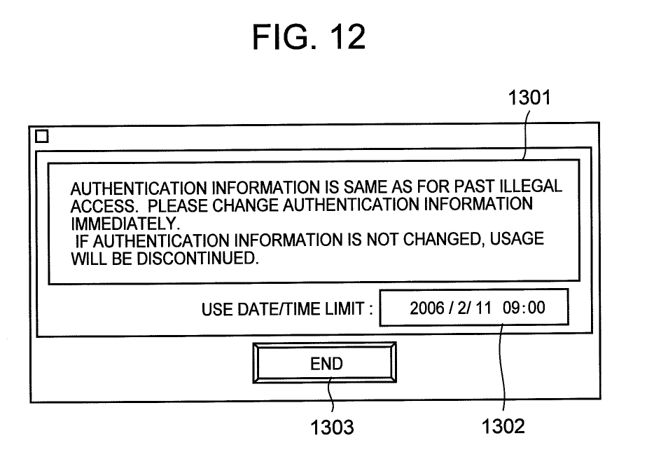

FIG. 12 shows an example of a screen 1300 displayed in the display apparatus 35 of the client terminal 30 which has received the event notification. As shown in the figure, the screen 1300 includes a message display section 1301 which displays a message to be displayed, a use time limit date display section 1302 which displays a date, after the use time limit T from the flag time 902, as a use time limit date, and an “END” button 1303 which receives an intention to end the present screen display.

On the other hand, if it is determined in step 1205 that the difference T3 between the current time and the flag time 902 exceeds the use time limit T (step 1207), the time limit monitor function performs control so as not to receive access from any users (step 1208). This process is similar to the process of the first embodiment where the access control program stops access from the users. Then, −1 is substituted for the flag 216 of the user information table 210. Information indicating the access stop is notified as an event notification to the client terminal 30 used by the legitimate user (step 1209), and processing returns to step 1202.

100

If it is determined in step 1203 that there is no user where the value of the flag 216 is equal to or more than 0, and if “UNUSED” is stored in the state 213, the process returns to step 1202.

Thus, according to this embodiment, in a state where safety is not necessarily secured even for the legitimate user because of the occurrence of competition, a limit is imposed to prevent use for over a fixed time. In other words, according to this embodiment, in addition to the effects of the first embodiment, continuous use by a user in an unstable state can be prevented.

### Third Embodiment

Next, a third embodiment of the present invention will be described. According to this embodiment, exclusive control which enables only a legitimate user to access a blade PC 20 is carried out without using a switch L2SW. This embodiment is basically similar to the first and second embodiments, and thus only differences will be described below. A different configuration will be described by taking the example of the second embodiment.

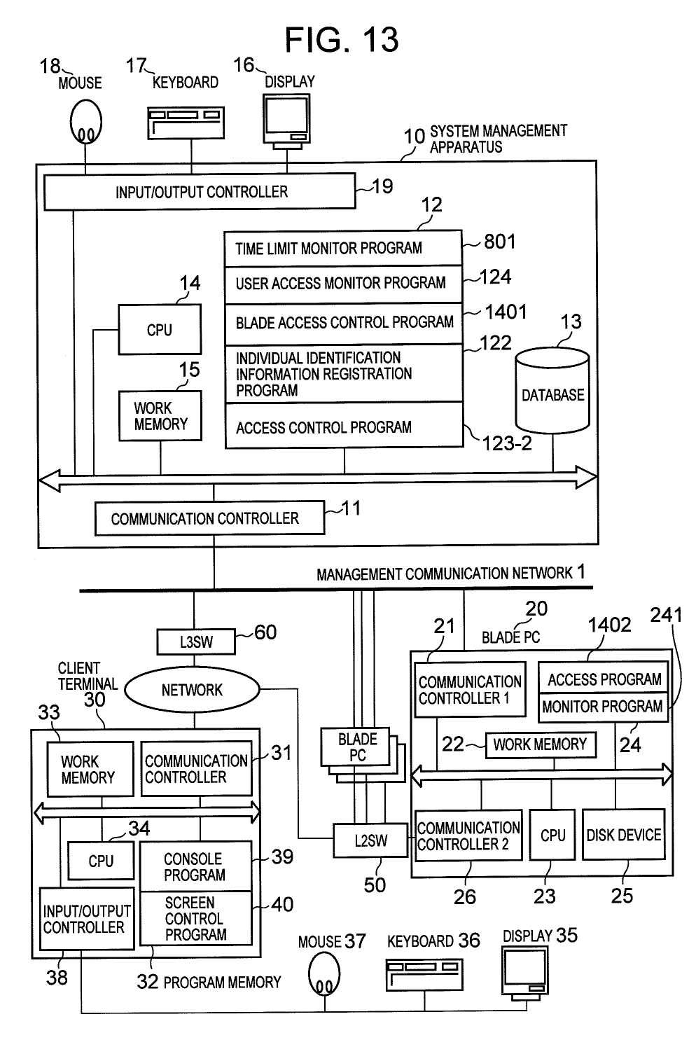

FIG. 13 is a diagram showing a configuration of a blade PC system according to this embodiment. A system management apparatus 10 of this embodiment includes a blade access control program 1401 in place of the switch control program. A blade PC 20 of this embodiment further includes an access program 1402.

The blade access control program 1401 is executed by a CPU 14 to realize an access control function. The blade access control function controls access from a client terminal 30 to the blade PC 20.

The access program 1402 is executed by a CPU 23 to realize an access function. The access function executes setting to filter input/output commands and input/output data transmitted and received via first and second communication controllers 21 and 26 in the blade PC 20. Normally, it is presumed that filtering holding a general security level is set in the blade PC 20 by the access function. For example, an input TCP packet for a port 80 is not accepted.

According to this embodiment, an operation at the time of receiving a request, such as a use request, is basically similar to that of the second embodiment. According to the second embodiment, if the blade PC 20 allocated to the user of the use request source has been used at the time of receiving the use request, the switch control program 121 of the system management apparatus 10 closes the connection port of the target blade PC 20 of the switch L2SW50 (step 505). However, according to this embodiment, when a use request is received in a similar state, the blade access control function makes a closing request to an access function of the used blade PC 20.

Upon reception of a closing instruction from the blade access control function of the system management apparatus 10, the access function of the blade PC 20 filters inputting/outputting of data from a port number used by the client terminal 30, or performs control to cut off access from all terminals excluding the system management apparatus 10.

Subsequently, as in the case of the first and second embodiments, a process of specifying a legitimate user among competing users is carried out.

According to the first and second embodiments, when the user side which is currently used is specified to be a legitimate user, the switch control function releases the access control set in the L2SW50. However, according to this embodiment, the blade access control function notifies an IP address of a client terminal 30 permitted to be connected, to the access function of the blade PC 20. When a user side currently being used is a legitimate user, an IP address of the client terminal 30 used by the user is notified.

The access function of the blade PC 20 which has received the notification executes setting so that only a packet from a designated IP address can be received by a port used by a screen control function of user client terminal 30. In this case, setting may be executed to receive a packet from the system management apparatus 10.

On the other hand, if the user who has transmitted the new use request is specified to be a legitimate user, according to the second embodiment, the switch control function changes the control of the L2SW50. According to this embodiment, however, the blade access control function notifies an IP address of the client terminal 30 permitted to be connected, in other words, the client terminal 30 used by a user who is specified as a legitimate user and has transmitted a new use request in this case, to the access function of the blade PC 20. The access function which has received the notification executes setting so that only a packet from the notified IP address can be received by the port used by the screen control function of the client terminal 30. In this case, setting may be executed to receive a packet from the system management apparatus 10.

Thus, according to this embodiment, even if the L2SW connected to the blade PC 20 includes no access function, the packet received in the blade PC 20 can be filtered. According to this embodiment, when competition occurs, by using this function of the blade PC 20 to realize exclusive control, control can be carried out to permit use only to the legitimate user.

### Fourth Embodiment

Next, a fourth embodiment will be described. According to this embodiment, access control is carried out in a blade PC 20. Each blade PC 20 recognizes only a user ID allocated to itself.

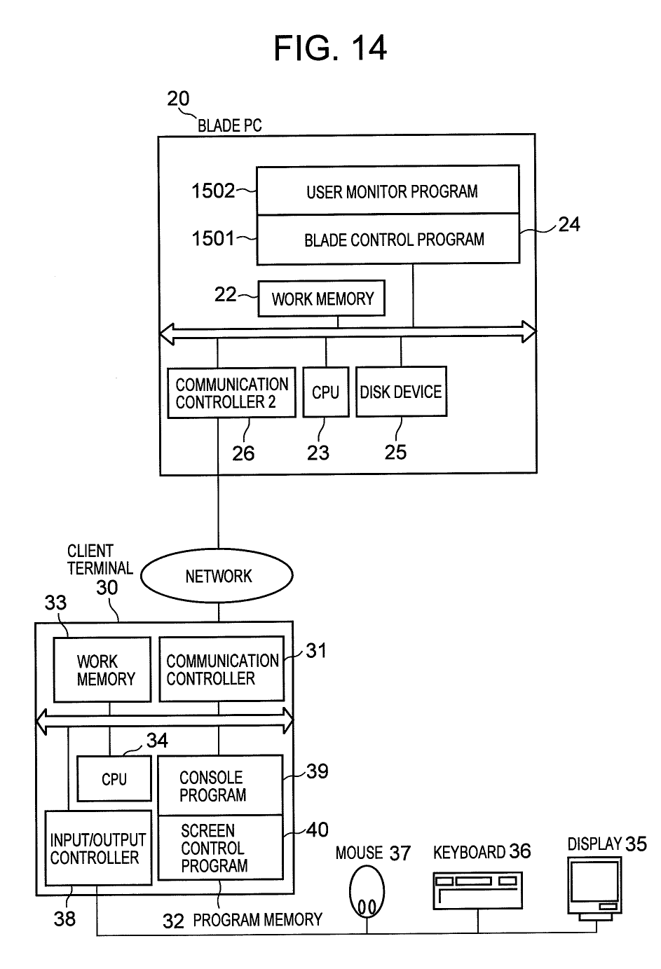

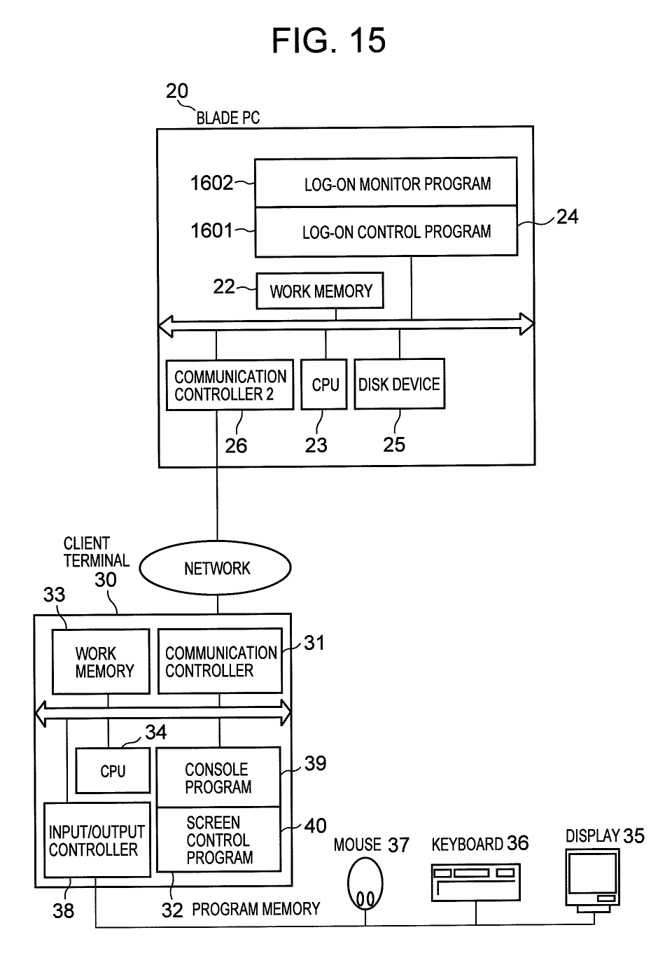

FIG. 14 is a diagram showing a configuration of a blade PC system according to this embodiment. As shown in the figure, the blade PC system of this embodiment includes a blade PC 20, a client terminal 30, and a network 2 to which both are connected. Different from the first to third embodiments, no system management apparatus 10 is installed.

A configuration of the client terminal 30 is similar to that of each of the first to third embodiments, and thus a description thereof will be omitted.

A configuration of the blade PC 20 of this embodiment is basically similar to that of each of the first to third embodiments. However, according to this embodiment, because the system configuration includes no system management apparatus 10, no first communication controller 21 is provided to communicate with the system management apparatus 10. In a program memory 24, a user monitor program 1502 and a blade control program 1501 are stored.

A disk device 25 stores a user authentication information table 300. In place of a user information table 210, a user information temporary recording table recording an identifier of a client terminal 30, log-on time, and log-off time corresponding to a user ID is held. According to this embodiment, it is presumed that the blade PC 20 has been started up, and that a log-on request has been transmitted from a user via the client terminal 30.

The user monitor program 1502 is loaded in a work memory 22, and executed by a CPU 23 to realize a user monitor function. The user monitor function detects log-on, log-off, interruption, or forcible cut-off of a user to monitor a state of the user. Upon detection of logging-on of the user, log-on time is recorded together with an identifier (connection terminal 215) to specify a client terminal 30 used by the user in the user information temporary recording table corresponding to an ID of the user who has logged on. Upon detection of logging-off, interruption, or forcible cutting-off, time of logging-off or the like is further recorded corresponding to the user ID. When logging-off is detected, data registered corresponding to the user ID may be deleted.

The blade control program 1501 is executed by the CPU 23 to realize a blade control function. The blade control function basically realizes a function similar to a function which combines the access control function of the system management apparatus 10 and the access function of the blade PC 20 of the third embodiment. In other words, the blade control function controls access from the client terminal 30. When competition occurs, control is executed to request inputting of additional authentication information and to determine a legitimate user, thereby permitting continuous use of the legitimate user. Then, the number of pieces of authentication information to be input is decided. The blade control function determines the occurrence of competition based on the contents recorded in the user information temporary recording table. In other words, in a case where log-on time has been recorded while no log-off time has been recorded, the occurrence of competition is determined.

As described above, according to this embodiment, even if there is no system management apparatus 10, when competition occurs, control can be executed to give continuous use permission to the legitimate user, and security can be maintained as in the case of the other embodiments.

### Fifth Embodiment

A fifth embodiment of the present invention will be described. A blade PC system of this embodiment is basically similar in configuration to the blade PC system of the fourth embodiment. According to this embodiment, while a log-on function generally installed in a PC is maintained, control of the invention, in other words, control which enables continuous use of a legitimate user and strengthens security, is executed.

A client terminal 30 is similar in configuration to that of each of the first to fourth embodiments. A blade PC 20 has a configuration similar to that of the fourth embodiment. In other words, a disk device 25 of the blade PC 20 of this embodiment stores a user authentication information table 300 as in the case of the fourth embodiment.

In a program memory 24 of the blade PC 20 of this embodiment, a log-on monitor program 1602 and a log-on control program 1601 are stored.

The blade PC 20 can log on a user ID and a password as authentication information as in the case of a normal PC, and realize an optional process immediately after the logging-on.

The log-on monitor program 1602 is loaded in the work memory 22 to be executed by the CPU 23, thereby realizing a log-on monitor function. The log-on monitor function monitors a log-on state of a user. Upon reception of a log-on request from the user, as in the case of the fourth embodiment, corresponding to a user ID, an identifier of a client terminal 30, log-on time, and log-off time are recorded in the user information temporary recording table. A process of the log-on monitor function will be described below in detail.

The log-on control program 1601 is loaded in the work memory 22 to be realized by the CPU 23, thereby realizing a log-on control function. The log-on control function executes a process when the user logs on. Upon reception of a log-on request from the user via the client terminal 30, the log-on control program is started up. The process will be described below in detail.

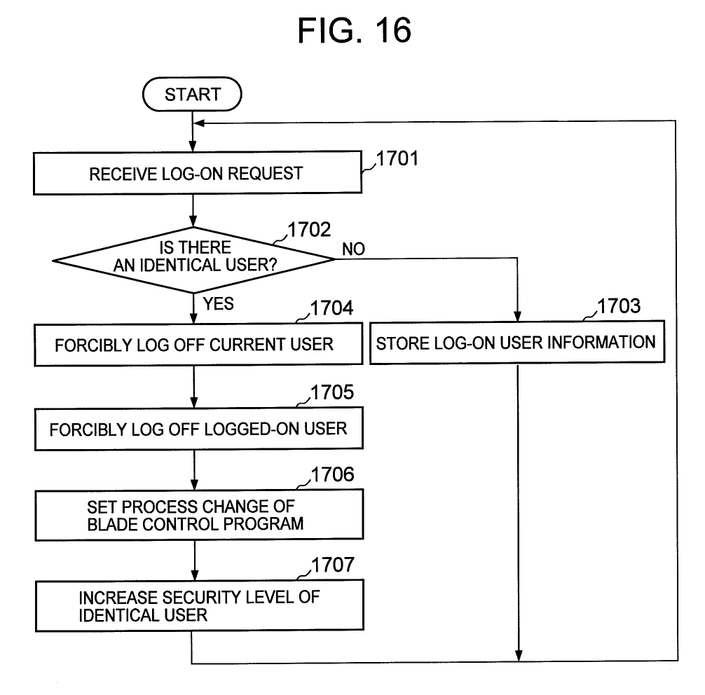

Next, the log-on monitor process realized by the log-on monitor function will be described. FIG. 16 shows flow of the log-on monitor process of this embodiment.

Upon reception of a log-on request from the client terminal 30 in a standby state (step 1701), the log-on monitor function extracts authentication information containing a user ID included in log-on information. When validity of the authentication is determined by a procedure similar to that of each of the first to third embodiments, and the validity is confirmed, a use state based on the ID of the user who has transmitted the log-on request is checked (step 1702). In this case, a determination is made as to whether a user ID identical to the extracted user ID has been recorded as a log-on state in the user information temporary recording table.

If the user ID has not been recorded in the log-on state, in other words, if there is no recording, or log-off time has been recorded, the received user ID and the log-on time are recorded in the user information temporary recording table (step 1703).

On the other hand, if it is determined in step 1702 that the user ID has been recorded in the log-on state, determining that competition has occurred, the log-on monitor function forcibly cuts off a user registered in the user information temporary recording table as being logged on (forcible cutting-off) (step 1705). At this time, the time of forcible cutting-off is recorded in the user information temporary recording table.

Subsequently, as in the case of the third embodiment, access from the client terminal 30 used by the user of the log-on state is filtered. As in the case of the first to third embodiments, a process of specifying a legitimate user among competing users is carried out. Then, when the legitimate user is specified, setting is executed so that only a packet from an IP address designated by a port used by a screen control function of the client terminal 30 of the specified user can be received (step 1706).

Then, as in the case of the first to third embodiments, a security level is increased (step 1707). The process returns to the standby state.

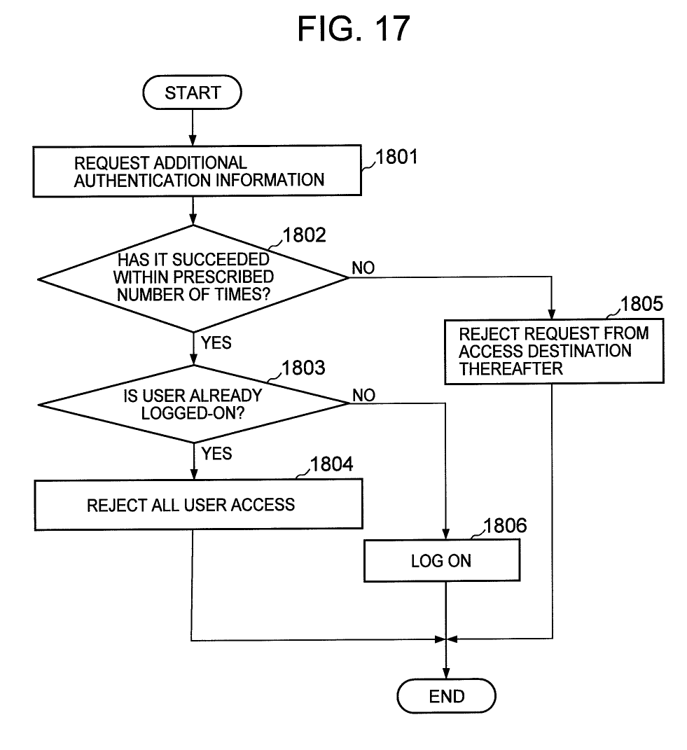

A log-on control process realized by the log-on control function of this embodiment when the security level is increased in step 1707, in other words, when inputting of a predetermined number of query words in addition to a normal user ID and a password is requested, will be described. FIG. 17 shows flow of the log-on control process of this embodiment.

After execution of a normal authentication process for logging-on, the log-on control function transmits screen data for displaying a dialog box to receive an entry of additional authentication information to the client terminal 30 of the authentication information transmission source to request additional authentication information (step 1801). For example, the screen data may be the additional information input screen 600 described above with reference to the first embodiment.

When additional correct authentication information is obtained within a prescribed number of times, and authentication is successful (step 1802), the log-on control function determines whether a user of the same user ID has been registered in the user information temporary recording table (step 1803). If the user has been registered, competition has occurred again. Thus, determining that security cannot be ensured, all sessions are logged off including that of the connected client terminal 30 (step 1804). Then, the log-on control function changes access control to inhibit access from any users, thereby finishing the process.

On the other hand, if no competition is determined to have occurred in step 1803, the log-on control function logs on as usual (step 1806) to finish the process.

If authentication is not successful within the prescribed number of times in step 1802, the log-on control function changes access control to inhibit access from a network segment related to an IP address of the client terminal 30 used by the user of the log-on request source (step 1805), thereby finishing the process.

As described above, according to this embodiment, access control when competition occurs can be carried out only by adding a program without changing the log-on process of the existing computer.

What is claimed is:

1. A computer system, comprising:
a server including a plurality of computers;
a client terminal; and
a server management apparatus which manages access from the client terminal to the server, wherein:
the server management apparatus includes:
an authentication information holding unit which holds authentication information and at least one piece of additional authentication information for each user;
an access control unit which receives a use request when authentication information matching the authentication information held in the authentication information holding unit is transmitted together with the use request for using the server, via the client terminal;
a use state determination unit which determines, upon reception of the use request by the access control unit, whether or not the server requesting a connection by the use request is in a competitive state in which the server is already being used according to the same authentication information; and
a startup control unit which requests transmission of the additional authentication information upon determining that the server is in the competitive state, permits connection of a user determined to be legitimate based on the requested additional authentication information, and cuts off connection of other users; and
the startup control unit determines, when only additional authentication information transmitted from one user matches the additional authentication information held in the authentication information holding unit, a user who has transmitted the matched additional authentication information to be a legitimate user.

2. The computer system according to claim 1, wherein the startup control unit requests, when pieces of additional authentication information transmitted from a plurality of users match the additional authentication information held in the authentication information holding unit, and when there is unused additional authentication information in the authentication information holding unit, transmission of pieces of different additional authentication information, from the plurality of users who have transmitted the pieces of matching additional authentication information, to determine a legitimate user.

3. The computer system according to claim 2, wherein:
the startup control unit records in the authentication information holding unit the number of pieces of additional authentication information that have been requested before determination of the legitimate user associated with the authentication information with which the competitive state was determined; and
the access control unit requests, from the client terminal, a number of pieces of authentication information equal to that of the pieces of requested additional authentication information in addition to the authentication information, when the number of pieces of additional authentication information recorded by the startup control unit is at least 1, and receives a request when all the pieces of the authentication information match.

4. The computer system according to claim 3, wherein the access control unit requests, of the client terminal, a change of the authentication information when the number of pieces of recorded additional authentication information requested by the startup control unit is at least 1, and sets the number of pieces of requested authentication information recorded by the startup control unit to 0 when new authentication information and additional authentication information are registered according to a request.

5. The computer system according to claim 1, wherein:
the startup control unit holds, when a legitimate user cannot be determined, information indicating that the determination could not be done, in the authentication information holding unit, in association with the authentication information; and
the access control unit does not accept a use request from a user when the information indicating that the determination could not be done is held in association with the authentication information, even when the user transmits authentication information matching the authentication information held in the authentication information holding unit.

6. The computer system according to claim 1, wherein:
the startup control unit records, when a competitive state is determined, a use time limit, in the authentication information holding unit, in association with the authentication information that is in the competitive state; and
the access control unit does not accept the use request when transmitted time exceeds the use time limit recorded in association with the authentication information, even when authentication information matching the authentication information held in the authentication information holding unit is transmitted together with the use request.

7. The computer system according to claim 1, further comprising:
a switch provided between the client terminal and the server; and
a switch control unit which controls the switch,
wherein, when the competitive state is determined by the startup control unit, the switch control unit controls the switch so that access from a client terminal being used by a user determined to be a legitimate user is permitted, while stopping access from a client terminal already connected.

8. The computer system according to claim 1, further comprising a server access control unit which controls access from the client terminal to the server,
wherein, when the competitive state is determined by the startup control unit, the server access control unit permits access from a client terminal being used by a user determined to be a legitimate user, while stopping access from a client terminal already connected.

9. A computer system, comprising:
a server including a plurality of computers; and
a client terminal, wherein:
the server includes:
an authentication information holding unit which holds authentication information and at least one piece of additional authentication information for each user;
request receiving unit which receives a use request when authentication information matching the authentication information held in the authentication information holding unit is transmitted together with the use request via the client terminal;
a use state determination unit which determines, upon reception of the use request by the request receiving unit, whether or not the server is in a competitive state in which the server is already in use according to the same authentication information; and
a startup control unit which requests transmission of the additional authentication information upon determining that the server is in the competitive state, permits connection of a user determined to be legitimate based on the requested additional authentication information, and cuts off connection of other users; and
the startup control unit determines, when only additional authentication information transmitted from one user matches the additional authentication information held in the authentication information holding unit, a user who has transmitted the matched additional authentication information to be a legitimate user.

10. An access control method in a computer system equipped with a server including a plurality of computers and a client terminal, which controls access from the client terminal to the server, the method comprising:
a request receiving step of receiving a use request when authentication information matching preregistered authentication information is transmitted together with the use request for using the server, via the client terminal;
a use state determining step of determining, upon reception of the use request, whether or not the server requesting a connection by the use request is in a competitive state in which the server is already being used according to the same authentication information; and
a startup control step of requesting transmission of preregistered additional authentication information when the server is determined to be in the competitive state, permitting connection of a user determined to be legitimate based on the requested additional authentication information, and cutting off connection of other users,
wherein the startup control step includes determining, when only additional authentication information transmitted from one user matches the preregistered additional authentication information, the user who has transmitted the matched additional authentication information to be a legitimate user.

11. A program for a computer system equipped with a server including a plurality of computers, and a client terminal, which controls access from the client terminal to the server the program controlling the computer to function as:
an access control unit which receives a use request when authentication information matching preregistered authentication information is transmitted together with the use request for using the server via the client terminal;
use state determining unit which determines, upon reception of the use request by the access control unit, whether or not the server requesting a connection by the use request is in a competitive state in which the server is already being used according to the same authentication information; and
a startup control unit which requests transmission of preregistered additional authentication information when the server is determined to be in the competitive state, determines, when only additional authentication information transmitted from one user matches the additional authentication information, the user who has transmitted the matched additional authentication information to be a legitimate user, and permits connection of the legitimate user while cutting off connection of other users.
